(19) United States
(12) Patent Application Publication
(10) Pub. No.: US 2024/0218869 A1
(43) Pub. Date: Jul. 4, 2024

(54) METHOD AND APPARTUS FOR THE PRESERVATION OF BEVERAGES WITH PUMP VENTING

(71) Applicant: LANXESS DEUTSCHLAND GMBH, Köln (DE)

(72) Inventors: Jonas BURGHOLZ, Köln (DE); Erasmus VOGL, Köln (DE); Gerhard SARTORIUS, Köln (DE); Axel KUBATZ, Köln (DE)

(21) Appl. No.: 18/562,872

(22) PCT Filed: May 24, 2022
(86) PCT No.: PCT/EP2022/064128

§ 371 Date: Nov. 21, 2023

(30) Foreign Application Priority Data
May 26, 2021 (EP) 21175892.5

(51) Int. Cl. F04B 49/22; A23L 3/00; A23L 3/3589; F04B 49/06; F04B 53/06

(52) U.S. Cl. CPC F04B 49/22; A23L 3/003; A23L 3/3589; F04B 49/06; F04B 53/06; F04B 2205/09

(57) ABSTRACT

A device for preserving beverages with a measuring device is provided which is suitable and intended to determine a flow rate of a liquid flowing through a beverage line, and with a pump device which conveys a preservative, in particular dialkyl dicarbonate, into the beverage line, into the beverage line, the pump device being controllable as a function of a flow rate determined by the measuring device, the device having a venting device for venting the pump device, wherein the venting device has a valve device.

The invention relates to a method and an apparatus for preserving beverages and the use of the apparatus for this purpose.

Preservatives such as dialkyl dicarbonates, sulphur dioxide, natamycin, benzoates or sorbates are used in the beverage industry for cold sterilisation of non-alcoholic carbonated or still fruit juice drinks, fruit juices, wines, non-alcoholic wines, ciders, iced teas and other beverages. Dialkyl dicarbonates, such as dimethyldicarbonate or diethyldicarbonate in particular, represent a special cold sterilising agent that has a number of advantages. The outstanding advantage lies in the fact that taste and colour are not affected, in contrast to hot filling. Also compared to persistent preservatives, such as sodium benzoate or benzoic acid or potassium sorbate or sorbic acid, the advantage is in particular the absence of any taste impairment and the disappearance of the effect. Due to the decomposition of the dialkyl dicarbonates into harmless components, no preservative is consumed by the actual consumer.

Compared to cold aseptic filling, the advantage of using dialkyl dicarbonates is the significantly lower investment costs in plant technology.

According to the state of the art, only on-line diaphragm dosing pumps are used for the addition of dialkyl dicarbonates. This is necessary because the amount of beverage to be treated is not fixed from the outset. One advantage of diaphragm pumps is that their pumping chamber is completely enclosed.

Diaphragm pump apparatus usually consists of a magnetically or electrically driven diaphragm pump, storage vessels, a device attached to the beverage line for atomising the dialkyl dicarbonate, a flow meter attached to the beverage line, and an electronic control system. Dosing pumps of this type are usually permanently installed in the beverage line.

The dosing pumps should be suitable for several different performance parameters, in particular for small and very small quantities. In addition, these dosing pumps should have a high dosing accuracy, a high atomisation pressure and a wide control range.

The mode of operation of these devices is based on the on-line measurement of the beverage flow rate prevailing in the beverage pipe and the quantity of dialkyl dicarbonate to be dosed calculated in parallel. Dialkyl dicarbonate is thus proportionally dosed into the beverage tube in the required quantity. Examples of these pumps are the VelcorinDT units from Lanxess.

In the treatment of beverages, for example non-alcoholic soft drinks or wine or mixed beer beverages, cold sterile treatment with dialkyl dicarbonates may be necessary, for example to control bacteria or yeasts. The aforementioned dosing devices are therefore used for treatment.

A dosing pump for the metered delivery of liquids is known from WO1998042983A1.

The dosing pumps used for such apparatuses and methods must fulfil different performance parameters. On the one hand, they should be suitable for feeding small or very small quantities. In addition, these dosing pumps should have a high accuracy, but at the same time also provide a high atomisation pressure and have a wide control range, in particular for the most diverse applications.

However, it has been shown that the preservatives used outgas to a certain extent. The pumps used in the state of the art react sensitively to outgassing media, which can lead to large dosing fluctuations or even a functional failure.

Based on the prior art, the object is therefore to stabilise the dosing process. This is achieved according to the invention by the subject matters of the independent patent claims. Advantageous embodiments and further developments are the subject of the subclaims.

An apparatus for preserving beverages according to the invention has a measuring device which is suitable and intended for determining a flow rate of a liquid flowing through a beverage line, and a pump device which conveys a preservative, in particular dialkyl dicarbonate, into the beverage line, and wherein the pump device can be controlled as a function of a flow rate determined by the measuring device.

According to the invention, the apparatus comprises a venting or degassing device for venting the pump device and this venting device comprises a valve device.

The invention described here serves in particular to take precautions to realise the dosing process as far as possible free of gas and in particular to safely remove gas bubbles from the pump device.

Preferably, the apparatus has a delivery line which opens into the beverage line and preferably the pump device delivers the preservative through this delivery line.

In the following, the term “venting” is used for simplification, even if the medium to be discharged is a gas other than air. Preferably, the gases are gases selected from a group of gases containing CO₂, methanol, methyl carbonate and dimethyl carbonate.

In a further preferred embodiment, the apparatus has a nozzle device and, in particular, a nozzle head which injects the preservative into the beverage line and/or atomises the preservative in the beverage line and/or in the beverage. This nozzle device or this nozzle head preferably projects into the beverage line at least in sections.

Preferably, the nozzle device or the nozzle head is a component of the delivery line and in particular forms an end of this delivery line.

Preferably, therefore, the pump device serves to inject the preservative into the beverage line and/or into the beverage. Preferably, the pump device is a pump device which is suitable and intended to convey a medium, such as the preservative in this case, under pressure and/or a pump device which is suitable and intended to cause atomisation of the preservative in the beverage line.

Preferably, the valve device is a controlled valve device. A controlled valve device is understood to be a (particularly active) valve device which can be actively actuated by a control process and which, in particular, does not open due to an overpressure or a flow movement, such as a non-return valve.

The invention thus describes an apparatus and a method for pump venting and in particular for pump head venting and in particular for fully automatic pump head venting. In addition, as described in detail below, a manual intervention option and/or an intervention option by a user is preferably also to be provided.

In a particularly preferred embodiment, the pump device is a dosing pump and in particular a diaphragm pump or a diaphragm dosing pump. Diaphragm pumps have proven to be suitable pumping devices to fulfil the criteria described above.

In a preferred embodiment, this pump device has a flow rate that is greater than 0.01 l/h and preferably greater than 0.02 l/h. Preferably, the pump device has a flow rate that is less than 60 l/h, preferably less than 50 l/h, preferably less than 40 l/h, preferably less than 30 l/h and preferably less than up to 20 l/h.

Preferably, the pump device can be controlled in a power range in which the ratio between the lowest flow rate and the highest flow rate is less than 0.1, preferably less than 0.01. In this way, a wide variety of requirements for the filling of beverages can be met with a single type of pump.

Preferably, the pump device delivers the preservative under pressure to a nozzle device, and preferably under a pressure that is between 5 bar and 100 bar, preferably between 15 bar and 50 bar.

Preferably, the beverage is conveyed through the beverage line with a flow rate of 40 l/h-80000 l/h.

Particularly preferably, the valve device described above serves to vent a pump head of the pump device and/or a predetermined area of the pump device in which outgassing media can collect and/or which forces the medium to be dosed in the direction of the beverage line. The pump head is sometimes also called dosing head or delivery unit in the literature. In particular, it is the area through which the medium to be conveyed flows (is sucked in and/or conveyed). Preferably, the pump head is limited by a suction valve, a pressure valve and a delivery element (such as a membrane of a piston or the like). Thus, the pump head could also be called a “dosing device”.

In a further preferred embodiment, the valve device is a solenoid valve. Solenoid valves or solenoid-controlled valves have the advantage that they can be switched very quickly and also at very high cycle speeds.

In a further advantageous embodiment, the apparatus has a control device for controlling the valve device and in particular the valve device designed as a solenoid valve. In particular, this control device is suitable for cyclically controlling the solenoid valve.

Particularly preferably, the control device is suitable and intended to control the valve device in response to or in consideration of a (delivery) movement of the pump device and in particular a pump stroke. For example, the solenoid valve can be controlled cyclically with every nth pump stroke (where n is preferably a natural number).

For example, the valve device can be controlled taking into account a position of an element of the pump device, for example taking into account the position of a pump piston, a diaphragm of a diaphragm pump or a position of a valve of the pump device (in particular if the pump device is a diaphragm pump). Preferably, a detection device is provided which detects this position. However, it would also be possible to obtain this data from a pump control.

Furthermore, as described in detail below, the control device is suitable and intended to control the valve device also depending on different operating modes of the apparatus. For example, it is possible that in a dosing mode, the valve device is opened cyclically in order to safely expel gas bubbles that arise in this dosing mode. The more detailed procedures are described below. This cyclical opening of the valve device is preferably adapted to the pump cycle of the pump device.

In a further preferred embodiment, the apparatus has a monitoring device for monitoring the venting process. In this way, it can always be monitored, even during operation, whether and to what extent venting is being carried out or may be necessary. The control of the valve can be adapted to this monitoring.

In a preferred embodiment, the valve device can also be actuated manually and/or by user intervention. For example, manual actuation of the valve device is also possible. In this way, for example, emergency actuation or emergency venting is possible. Thus, it is possible that a user directly actuates the valve device. However, it would also be possible for the user to actuate the valve device by means of a control device.

In a preferred embodiment, the valve device is a screw-in valve, i.e. a valve that can be screwed into a specific area of the pump device. Preferably, the valve device is a two-way valve.

It would be possible to arrange the valve for venting at different positions, for example also between the pump head and the nozzle device. However, in particular in a setup with a directly attached nozzle, an installation at the highest point in the pump head is advantageous.

In a preferred embodiment, the valve device has a seat seal and in particular a soft-seat seal. In addition, the valve device is particularly preferably designed with a low dead space.

This design has the (constructive) advantage that the valve inner volume (i.e. the part in contact with the medium) is as small as possible. In this way it is achieved that the efficiency of the pump device and the dosing accuracy are not influenced too much

It is thus achieved that the pumps have a very small “damage space” between the diaphragm and the nozzle. In this way, accuracy and reliability (in particular in connection with venting) can be improved.

In a further preferred embodiment, the valve device is arranged in a region of the pump device and, in particular, of a product chamber of the pump device, and/or the valve device is arranged (in relation to the medium to be conveyed) in an upper and, in particular, a highest region of the pump device and/or of the product chamber. The highest area is understood to be an area that is arranged highest in a vertical direction or in a direction directed towards the centre of the earth in comparison to other areas. Preferably, the valve device is arranged in such a way that a gaseous medium can collect in a region of the valve device.

In this way, venting of the pump device is possible in a particularly favourable manner. In particular, gas bubbles can be removed or discharged from the pump device in a particularly favourable manner.

In a further preferred embodiment, a line for conducting venting gases and/or a liquid (and in particular the liquid to be conveyed) is connected to the valve device (and in particular to an outlet of the valve device). In principle, it would also be possible to carry out the venting into the environment. However, especially with regard to the preservation agents, it is suggested that these are recirculated. In this case, it is possible that both gases and liquid are discharged during the venting process. For this reason, the line serves to feed these media at least partially, and in particular the liquid media, back into a circuit and/or back to the pump device. As will be described in more detail below, the discharged gas and/or liquid can be fed into a vessel via this line.

In a further preferred embodiment, the apparatus has a measuring vessel and/or a measuring device for detecting a level of a liquid and/or gaseous medium and preferably the line described above opens into this measuring vessel. The measuring vessel may, for example, be a measuring burette, i.e. a vessel which has a measuring scale. In general, in the context of the present invention, a measuring vessel is understood to be a device which has a receiving volume for receiving a liquid medium and which, in addition, enables this volume to be determined. A measuring vessel can also allow liquid to pass through it.

In a further advantageous embodiment, the apparatus has a receiving chamber for at least temporarily receiving a liquid medium discharged from the pump device via the valve device. This receiving chamber is preferably in flow connection with the above-described line which is connected to the valve device. This receiving chamber is preferably formed by the measuring vessel described above.

Preferably, the discharged gas or liquid quantity is conveyed via a line into a calibration vessel or measuring vessel on the suction side. Preferably, this measuring vessel is designed in such a way that a gas phase can escape and a liquid phase is or can be fed again into the process and/or the pump device.

Preferably, therefore, the apparatus and in particular the measuring vessel has a separating device in order to be able to separate gaseous and liquid components of the medium escaping via the venting valve. This separating device can also be formed by the shape of the measuring vessel itself.

Preferably, the measuring vessel has a filling level measuring device. Particularly preferably, this measuring vessel has a floating device, in particular for level measurement. However, other sensors are also possible which are suitable and intended for determining the filling level within a measuring vessel.

In a further preferred embodiment, the apparatus has an evaluation device for evaluating and/or determining the filling level (of the measuring vessel). For example, an image recording device such as a camera can be used, which monitors the filling level inside the measuring vessel. This filling level measuring device can also output data which can be used to control the pump device and/or the valve device.

In a further preferred embodiment, the apparatus has a sensor device that detects at least one parameter that is characteristic of the substance or media passed on from the valve device. For example, a flow measuring device can be provided in the line connecting to the valve device in order to determine the gaseous and/or liquid medium flowing in the line with regard to its flow rate.

In addition, a measuring device can also be provided which outputs a parameter that is characteristic of whether the escaping medium is a gaseous or a liquid medium.

Preferably, a temperature sensor can be used here (as a measuring device or sensor device). Preferably, this temperature sensor is kept at a suitable temperature (in particular electronically controlled). As soon as liquid medium is passed on from the valve device and meets the temperature sensor, the temperature of the sensor changes, because the temperature of the liquid is preferably somewhat lower than that of the sensor. The temperature sensor can thus provide a signal for the control system to detect the backflowing medium.

However, other measuring methods could also be considered, such as ultrasonic measurement or mass flow detection. However, a calorimetric method for flow detection is preferred, as described.

Based on the measured values of this sensor device, it can be determined whether gas is escaping from the pump or whether liquid is already escaping.

Particularly preferably, a sensor device is thus provided and, in particular, a sensor device is installed in the said line which monitors the venting function. As long as, for example, a gas flows past the sensor device, the venting process is to be continued. If liquid flows along the sensor device, the venting is successfully completed.

In a further preferred embodiment, the measuring vessel has an inlet for a liquid and/or an outlet for a liquid, wherein this outlet being in flow connection with the pump device. Preferably, the measuring vessel also has a discharge device for discharging a gaseous medium. This discharge device can have a filter device for filtering the medium to be discharged.

The measuring vessel or measuring burette on the suction side preferably has a float, as mentioned above, with the help of which the level in the vessel is monitored and, in particular, a calculation of the actual dosing quantity of the pump is made possible in normal operation.

During a pump ventilation, for example when the pump device is operating and the valve device is open, the level in the measuring vessel drops because the pump sucks in liquid but discharges gas via the solenoid valve. When in this operating procedure the pump ventilation in the ventilation operation is successfully completed, the amount of liquid sucked in by the pump balances the amount supplied to the measuring vessel via the valve and the line or return line. In this state, the level in the measuring vessel remains stable.

In a further preferred embodiment, the apparatus comprises at least one temperature measuring device for detecting a temperature of at least one element of the pump device. Preferably, the corresponding element is the pump head and/or a piston and/or a diaphragm section of the pump device or, in general, a movable element of the pump device which is in direct contact with the medium to be pumped. Elevated temperatures (but temperatures below 45° C.) increase decomposition processes of the dimethyldicarbonate and thus the gas phase formation.

Particularly preferably, the above-mentioned control device also controls the valve device taking this measured temperature into account. For example, the control device can shorten the intervals of the cyclic vent strokes and/or the intervals of the valve openings.

The present invention is further directed to a method for preserving beverages, wherein a flow rate of a liquid flowing through a beverage conduit is determined by means of a measuring device and a preservative and in particular dialkyl dicarbonates are conveyed into the beverage line by means of a pump device, wherein a delivery line opens into the beverage line and the pump device conveys the preservative through this beverage line and wherein the pump device is controlled in dependence on a flow rate determined by the measuring device.

According to the invention, the pump device is vented at least temporarily by means of a venting device, wherein this venting being effected by means of a controlled valve device. It is therefore also proposed on the method side that controlled venting of the pump device takes place at least in some operating states.

Particularly preferably, the pump device can be operated in different operating states. In a preferred method, the valve device is cyclically controlled in a working mode and/or the valve device is controlled in a working mode taking into account a pumping mode of the pump device.

For example, it is possible that in a dosing operation the valve device, which is in particular a solenoid valve, is opened cyclically in order to reliably expel gas bubbles that occur during operation. Preferably, this opening of the valve device takes place before the subsequent dosing stroke and preferably in a predefined period of time before this dosing stroke.

Preferably, this predetermined time period is less than 0.5 s, preferably less than 0.3 seconds, preferably less than 0.2 s, preferably less than 0.1 seconds, preferably less than 0.08 s, preferably less than 0.06 s, preferably less than 0.05 s, preferably less than 0.04 s, preferably less than 0.03 s, preferably less than 0.02 s.

Preferably, this time period is greater than 1/100 s, more preferably greater than 2/100 s and more preferably greater than 3/100 s.

In this way, valve actuation is possible in a depressurised state or at a low internal pump pressure. In this way, the dosing accuracy of the pump device is only slightly influenced and, on the other hand, only a small amount of force is required for the solenoid valve or for its actuation.

In addition, venting can also be carried out during production pauses in an operating mode in which production is taking place, but no pump operation is taking place that introduces the preservative into the beverage line. In this case, the valve device can be opened cyclically in order to reliably discharge any gas bubbles that arise and/or in order to dose with the required accuracy during the next pump stroke.

Furthermore, the apparatus is preferably operated in a operating mode heating and/or is operated at least temporarily in this mode. This is in particular a waiting position before the arrival of a further batch of the beverage to be filled. In this operating mode, cyclical automatic pump strokes are preferably triggered when a valve is open. In this operation, pump readiness is preferably maintained despite the formation of gas bubbles in the pump head, wherein these gas bubbles are cyclically discharged in this operation.

As mentioned above, increased heat conduction towards the pump head can occur with higher temperature exposure, wherein increased temperatures increase decomposition processes and thus gas bubble formation. Preferably, the intervals of the cyclic venting strokes (as described above under the operating mode heating) are changed here and in particular shortened. Preferably, the system control enables an operating mode venting that can be selected manually or generally by user intervention and in which the pump device is operated with an open valve in a (advantageously fixed) time interval. In this operating mode, an intensive venting or degassing process takes place.

In a further preferred method, a gaseous and/or liquid medium discharged via the valve device is passed into a vessel and in particular a measuring vessel. In a further preferred method, a medium discharged via the valve device is analysed to determine whether it is a gaseous or a liquid medium.

In a further preferred method, a temperature of at least one element of the pump device is determined at least temporarily.

Further advantages and embodiments can be seen in the attached drawings:

In the drawings:

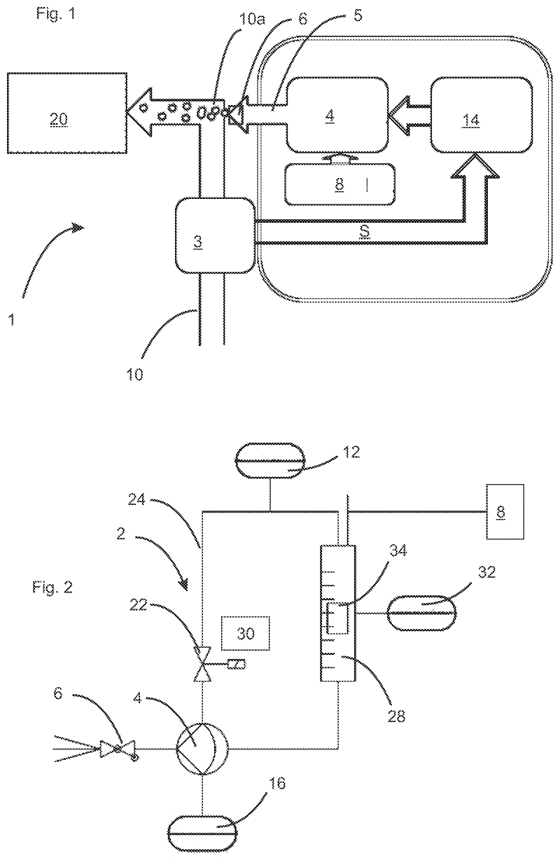

FIG. 1 shows a schematic representation of an apparatus according to the invention:

FIG. 2 shows a detailed illustration of the venting process.

FIG. 1 shows an apparatus 1 for preserving beverages according to the internal prior art of the applicant. Here, the reference sign 10 refers to a beverage line via which a liquid to be filled into containers, and in particular a beverage, is supplied to a filling machine 20. The reference sign 2 indicates a flow measuring device which determines or measures a flow of the beverage through the beverage line 20. This flow measuring device 3 outputs a control signal S to a control device 14. This control device 14 controls the pump device 4 taking this control signal S into account.

The pumping device 4 pumps a preservative from a reservoir 8 and delivers it via a nozzle head 6 into the beverage line 10, more precisely here in a curved region 10a of the beverage line 10. The reference sign 5 indicates a delivery line and preferably the nozzle head is also a component of this delivery line 5.

FIG. 2 shows a more detailed illustration of the invention. Here again the pump device 4 is shown, which in this case is a diaphragm pump, in particular a dosing pump.

A valve device 22 is provided at a (preferably) upper area of this pump device, which is a component of the venting device designated in its entirety as 2. This valve device 22 is, as mentioned above, preferably a solenoid valve. This solenoid valve can be controlled by a control device 30 (only shown schematically) to open and close.

A venting line 24 is connected to this solenoid valve device 22. The reference sign 3 indicates a measuring device which determines whether a gaseous or liquid medium flows in this venting line 24. In this way it can be determined whether the venting is successful or whether there is still air or gas in general in the pump device 4.

The line 24 preferably opens into a measuring vessel 28, which has a float device 34 and a scale with which the level of the liquid in the measuring device 3 or the measuring vessel 28 can be checked.

The reference sign 32 indicates an optionally available sensor device which detects a filling level of the liquid in the measuring container. The data from this measuring device 32 is also preferably used to control the valve device 22 and/or to control the pump device 4.

The reference sign 16 indicates an optionally available temperature measuring device which measures a temperature of at least one element of the pump device 4 and in particular a temperature in the area of the pump head. Depending on this temperature, a degassing behaviour within the liquid to be dosed can also change. Preferably, data from this temperature measuring device 16 is therefore also used to control the valve device 22 and/or the pump device 4.

In addition, data relating to the operation of the pump device 4 itself is preferably also used to control the valve device 22. For example, data characterising the position of a pump element such as a pump piston or the like can be used. This data is also preferably used to control the valve device 22. For example, it is possible that the valve device 22 is always actuated at a certain time, for example as mentioned above shortly before another pump stroke is due.

Preferably, dialkyl dicarbonates are used as preservatives. Very particularly preferably dimethyldicarbonate is used, even more preferably dimethyldicarbonate with a purity >99.8% is used as preservative. In a further embodiment of the invention, dimethyldicarbonate is used which has been stabilised by suitable processes.

Such methods, such as the use of a phosphorus compound from the Series Phosphorus oxides, phosphorus-oxygen acids and their derivatives are for example known from EP 2 013 160 B1. EP 2 016 041 B1 describes the use of at least one protonic acid chosen from inorganic acids and organic carboxylic acids and derivatives thereof, wherein the organic carboxylic acids 20 being saturated and mono- or polyunsaturated aliphatic monocarboxylic acids and saturated and mono- or polyunsaturated aliphatic di- and polycarboxylic acids and, in the case of derivatives thereof, hydroxamic acids, hydroxycarboxylic acids, aldehyde and keto acids, for stabilising dialkyl dicarbonates against chemical and thermal degradation reactions, wherein the protonic acid or mixtures thereof being used in an amount of 0.01 to 100 000 ppm relative to dialkyl dicarbonates or mixtures thereof.

In a further embodiment of the invention, dimethyldicarbonate is used in a mixture with phosphorus compounds, such as preferably phosphates, even more preferably with trimethyl phosphate or phosphoric acid. Preferably, the phosphorus compound 30 is used an amount between 0.01 ppm and 1000 ppm based on the total amount of the mixture of dimethyl dicarbonate and phosphorus compounds.

The applicant reserves the right to claim all features disclosed in the application documents as essential to the invention, provided they are individually or in combination new compared to the prior art. It is further pointed out that the figure also describes features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

### LIST OF REFERENCE SIGNS

1 apparatus
2 venting device
3 measuring device
4 pump device
5 delivery line
6 nozzle head
8 reservoir
10 beverage line
10a curved area
12 monitoring device
14 control device
16 temperature detection device
18 temperature measuring device
20 beverage line
22 valve device
24 line/venting line
28 measuring vessel
30 control device
32 sensor device
34 float device

1. An apparatus for preserving beverages, having a measuring device which is suitable and intended for determining a flow rate of a liquid flowing through a beverage line, and having a pump device which conveys a preservative, into the beverage line, wherein the pump device being controllable as a function of a flow rate determined by the measuring device, wherein the apparatus having a venting device for venting the pump device wherein the venting device has a valve device.

2. The apparatus according to claim 1, wherein the valve device is a solenoid valve.

3. The apparatus according to claim 1, wherein the apparatus comprises a control device for controlling the valve device.

4. The apparatus according to claim 1, wherein the apparatus comprises a monitoring device for monitoring the venting process.

5. The apparatus according to claim 1, wherein the valve device can also be actuated manually and/or by user actuation.

6. The apparatus according to claim 1, wherein the valve device is arranged in a region of a pump head of the pump device and/or the valve device is arranged in a highest region of the pump device.

7. The apparatus according to claim 1, wherein a line for conducting venting gases and/or a liquid is connected to the valve device.

8. The apparatus according to claim 1, wherein the apparatus has a measuring vessel for detecting a level of a liquid and/or gaseous medium.

9. The apparatus according to claim 8, wherein a line for conducting a gaseous and/or liquid medium, which is connected to the valve device, opens into the measuring vessel.

10. The apparatus according to claim 1, wherein the measuring vessel has an inlet for a liquid and/or an outlet for a liquid, wherein this outlet being in flow connection with the pump device.

11. The apparatus according to claim 1, wherein the apparatus comprises at least one temperature measuring device for detecting a temperature of at least one element of the pump device.

12. A method for preserving beverages, wherein a flow rate of a liquid flowing through a beverage line is determined by means of a measuring device and a preservative is conveyed into the beverage line by means of a pump device, wherein a delivery line opening into the beverage line and the pump device delivering the preservative through this beverage line, and wherein the pump device being controlled as a function of a flow rate determined by the measuring device, wherein the pump device is vented at least temporarily by means of a venting device, wherein this venting being carried out by means of a controlled valve device.

13. The method according to claim 12, wherein in a working mode the valve device is controlled cyclically and/or in a working mode the valve device is controlled taking into account a pumping operation of the pump device.

14. The method according to claim 12, wherein a gaseous and/or liquid medium discharged via the valve device is passed into a vessel and a measuring vessel and/or a medium discharged via the valve device is analyzed in order to determine whether it is a gaseous or a liquid medium.

15. The method according to claim 12, wherein a temperature of at least one element of the pump device is determined at least temporarily.

16. The apparatus for preserving beverages of claim 1, wherein the preservative is dialkyl decarbonates.

17. The method for preserving beverages of claim 12, wherein the preservative is dialkyl decarbonates.
